(19) United States
(12) Patent Application Publication
(10) Pub. No.: US 2015/0298406 A1
(43) Pub. Date: Oct. 22, 2015

(54) INFLATABLE STRUCTURE

(71) Applicant: NEIL PRYDE LIMITED, New Territories, Hong Kong (CN)

(72) Inventor: Kevin Costin, Hong Kong (CN)

(21) Appl. No.: 14/443,308

(22) PCT Filed: Nov. 15, 2013
(86) PCT No.: PCT/IB2013/002557

§ 371 Date: May 15, 2015

(30) Foreign Application Priority Data
Nov. 16, 2012 (HK) 12111729.1
Dec. 13, 2012 (HK) 12112903.7
Feb. 8, 2013 (HK) 13101846.9

(51) Int. Cl. B29D 22/02; B63B 35/79

(52) U.S. Cl. CPC B29D 22/02; B63B 35/7913; B63B 2035/7903; B29K 2313/00; B29K 2105/258

(57) ABSTRACT

An inflatable structure and in particular, although not exclusively, a device such as an inflatable water craft, a kite or a shelter. Also an inflatable tube for an inflatable structure.

### BACKGROUND INFORMATION

The present invention relates to inflatable structures and in particular, although not exclusively, to a device such as an inflatable water craft, a kite or a shelter. The invention also relates to an inflatable tube for an inflatable structure.

Inflatable products are popular due to their light weight and ease of storage when deflated. Hitherto, inflatable products have been more commonly available in the toy or leisure markets. However, with modern materials such as fabrics, plastics and resins, and improved manufacturing techniques, higher quality performance orientated inflatable products are becoming increasingly available. As well as being lighter and more easily stored and transported in a deflated state, inflatable products made from modern materials are more durable and less prone to damage from bumps and knocks than their rigid plastic or composite material counterparts.

Many modern sports-kites use an inflatable leading edge and spars due to their superior weight, buoyancy and storage characteristics. Hitherto, these leading edges and spars have been achieved by providing an inflatable bladder inside a suitably shaped sleeve or pocket. It is desirable to have a bladderless alternative to the current design. In particular, it is desirable to have a small diameter leading edge and spar which can aid in achieving an improved drag to lift ratio.

Inflatable watercraft have been known for some time and have been popular due to their superior weight, buoyancy and storage characteristics. Inflatable surfboards and the like are described in US patent application publications 20090049757 and 2003015322 and in U.S. Pat. Nos. 6,066,016 and 2,743,510, the entire contents of which are incorporated herein by reference. These disclosures are directed at products with increased strength and stiffness, but suffer from rather rudimentary shape and styling due to limitations in their construction techniques. It is desirable to provide an alternative inflatable structure that offers suitable strength and stiffness as well as allowing for improvements in the shaping and style of inflatable watercraft, or which at least provides those skilled in the art with a useful alternative.

### SUMMARY OF THE INVENTION

Accordingly, one or move inventions are described herein and set for in the accompanying claims.

In particular, although not exclusively, in one aspect the invention provides for an inflatable structure comprising an envelope having a first airtight shape-forming chamber and a second chamber, and wherein, in use, the shape-forming chamber is inflatable to a first pressure that is higher than a second pressure of the second chamber.

Preferably, the second chamber is an airtight chamber and, in use, the second chamber is inflatable to a pressure higher than atmospheric pressure but less than the first pressure.

Preferably, the shape-forming chamber at least partially surrounds the second chamber.

Preferably, the shape-forming chamber defines an edge of the envelope.

Preferably, the envelope includes an upper wall having an upper wall edge, the upper wall attached to the shape-forming chamber along the upper wall edge, and the upper wall also defining a wall of the second chamber.

Preferably, the envelope includes a lower wall having a lower wall edge, the lower wall attached to the shape-forming chamber along the lower wall edge, and the lower wall also defining a second wall of the second chamber.

Preferably, the inflatable structure further includes a secondary shape-forming member joined between the upper wall and the lower wall, the secondary shape-forming member defining a maximum distance between the upper and lower walls.

Preferably, the inflatable structure further includes a plurality of said secondary shape-forming members extending longitudinally and/or transversely within the envelope.

Preferably, the secondary shape-forming member(s) is/are one or more threats joint the upper wall and the lower wall.

Preferably, the secondary shape-forming member(s) is/are one or more ribs joint the upper wall and the lower wall and extending through the envelope to divide the second chamber into two or more secondary chambers.

Preferably, the secondary shape-forming member(s) is/are one or more second airtight shape-forming chambers inflatable for a third pressure higher than the second pressure and equal or lower than the first pressure.

Preferably, the secondary shape-forming members are attached to the upper wall and the lower wall and to adjacent shape-forming members, such that when inflated each secondary shape-forming member has an oval shape wherein its height is greater than its width.

Preferably, the secondary shape-forming members define a different maximum distance between the upper wall and the lower wall at two or more positions spaced apart longitudinally and/or transversely such that the upper wall and lower wall are not parallel in a respective longitudinal or transverse direction.

Preferably, the first airtight shape-forming chamber is an inflatable tube having a pre-shaped tube wall, the tube wall comprising flexible stretch resistant threads or fibres bonded together by an elastic plastic.

Preferably, the flexible stretch resistant threads or fibres are a woven tubular sock.

Preferably, the elastic plastic is thermoplastic polyurethane (TPU).

Preferably, the shape-forming chamber is tapered from a middle portion or one end towards a second end.

Preferably, the shape-forming chamber has a curvilinear shaper when inflated.

Preferably, the upper wall and/or the lower wall are made from a material having an elasticity and/or a stiffness that is different to the elasticity and stiffness of the shape-forming members.

Preferably, the structure is a device selected from a group of devices consisting or, a water craft such as a kayak or canoe, a paddle board such as a stand-up paddle board (SUP), an inflatable wing, a kite, a shelter such as a tent, a non-rigid container such as a bag or backpack or bike bag, an aircraft rescue slide, and an inflatable advertising sign.

According to another particular aspect of the invention there is provided an inflatable structure comprising an envelope having an upper wall, a lower wall and a plurality of airtight shape-forming chambers at two or more positions spaced apart transversely through the envelope, wherein the shape-forming chambers are affixed with the upper wall and the lower wall and engageable with adjacent shape-forming chambers, such that when inflated each shape-forming chamber has an oval shape wherein its height between the upper and lower walls is greater than its width.

According to yet another particular aspect of the invention there is provided pre-shaped tube having a pre-shaped tube wall, the tube wall comprising flexible stretch resistant threads or fibres bonded together by an elastic plastic.

According to still another particular aspect of the invention there is provided a method of making a pre-shaped tube comprising, providing a forming member having a tapered and/or a curvilinear shape, applying a woven tubular sock to the forming member, deforming the woven sock to conform to the shape of the forming member, and applying an elastic thermoplastic to the woven sock to bond together threads or fibres of the sock.

Further inventions or aspects of the invention may become apparent from the following description which is given by way of example only.

### BRIEF DESCRIPTION OF THE DRAWINGS

In the accompanying drawings,

FIG. 1 is a cut-away section perspective view of a Stand-up Paddle Board (SUP),

FIG. 2 is a first end section view of the SUP,

FIG. 3 is a partial section view of the inflated SUP showing the shape-forming means,

FIG. 4 is a partial section view of the deflated SUP showing the shape-forming means of FIG. 3,

FIG. 5 is an upper view of the SUP showing the upper attachment plan of shape-forming ribs,

FIG. 6 is a lower view of the SUP showing the lower attachment plan of shape-forming ribs,

FIG. 7 is a view of panels used to make shape-forming ribs.

FIG. 8 is a second end section of the view of the SUP with a second X-type of secondary shape-forming means

FIG. 9 is a second end section view of the SUP with a third I-type of secondary shape-forming means,

FIG. 10 is a section view through a pre-shaped inflatable tube,

FIG. 11 is a pre-shaped of a tube and shaping mould,

FIG. 12 illustrates a cross ply pattern of a woven sock, and

FIG. 13 is a perspective side view of a SUP showing rocker.

### DESCRIPTION OF THE PREFERRED EMBODIMENTS

The following description is given by way of example only to illustrate the invention. It is not intended to limit the scope of use or functionality of the invention. In particular, the invention is not limited in its application to the details of construction and the arrangements of components set forth in the following description or illustrated in the accompanying drawings. The invention is capable of other embodiments and of being practiced or being carried out in various ways. Also, it is to be understood that the phraseology and terminology used is for the purpose of description and should not be regarded as limiting.

In one embodiment the invention provides for an inflatable structure suitable for use in numerous products including but not limited to water craft such as kayaks or canoes, surfboards, surf skis and paddle boards such as a stand-up paddle boards (SUPs), inflatable wings, sports kites such as those used in Kiteboarding, shelters such as tents and awnings, non-rigid containers such as bags, backpacks or bike bags, aircraft rescue slides and inflatable advertising signs. For the purpose of illustrating the invention the drawings show the invention applied to a stand-up paddle board (SUP), however, this is not intended to limit the scope of use or functionality of the invention which may be applied to any inflatable structure comprising an envelope. One embodiment of the invention discussed herein provides a pre-shaped inflatable structure having one or more pre-shaped inflatable tubes. The pre-shaped tubes may be inflated with bladders, or alternatively may be bladderless. In some embodiments the bladders used to inflate the pre-shaped tubes may themselves be pre-shaped tubes.

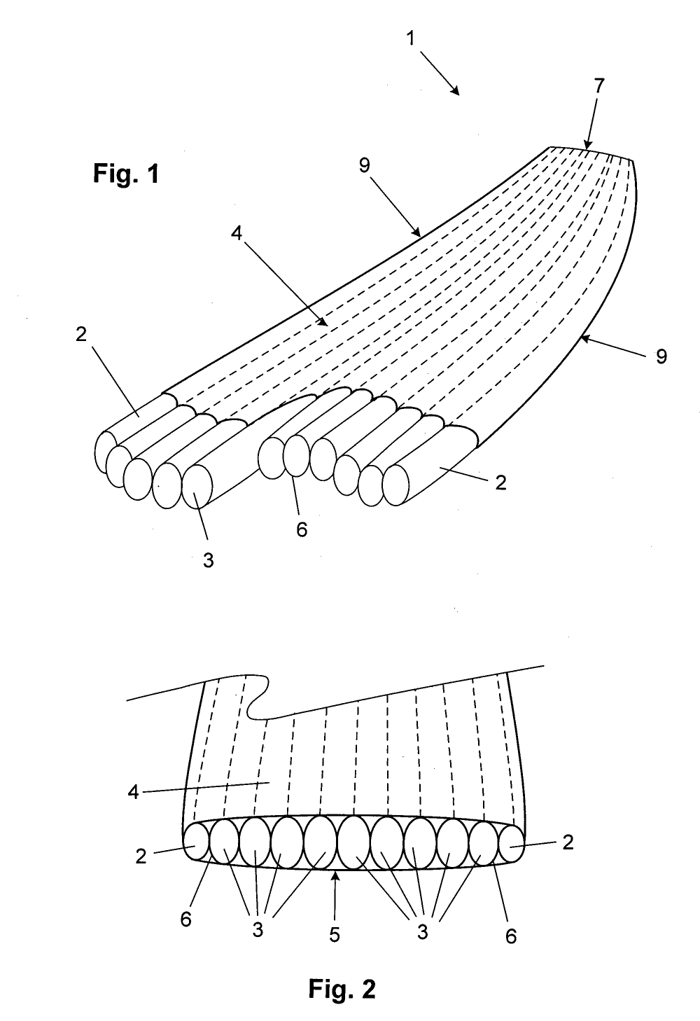

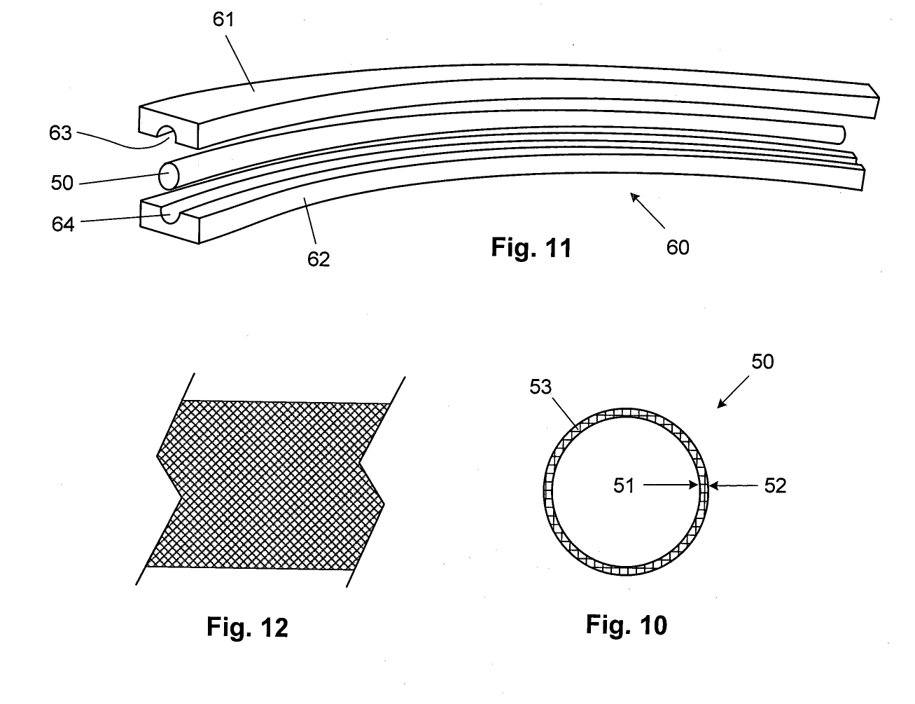

An inflatable structure according to the invention comprises an envelope 1 which forms the main body of the structure. In the illustrated embodiment, of FIG. 1 for example, the envelope 1 has a front or nose end 7, a back or tail end 8 and two elongate sides 9 joint between the nose 7 and tail 8. Such an envelope is suitable for use as a stand-up paddle board (SUP). The envelope 1 is formed from a plurality of pre-shaped chambers 2, 3 of which at least one chamber 2 is inflated to a pressure higher than atmospheric pressure to provide a shape-forming support structure for the envelope 1. In one embodiment the shape-forming chamber 2 is a pre-shaped inflatable tube 50 (see FIG. 10) made from a plurality of flexible stretch resistant threads or fibres that are bonded together by an elastic plastic such as thermoplastic polyurethane (TPU). Such a pre-shaped tube 50 can be made, for example, buy applying a woven tubular sock 53 to a shape-forming member having a desired tapered and/or a curvilinear shape. The sock 53 is deformed to the shape of the shape-forming member and an elastic thermoplastic 51, 52 is applied to the woven sock 53 to bond together the threads or fibres of the sock. The elastic thermoplastic 51, 52 locks the fibres or threads of the sock 53 to the shape of the forming member such that when the inflatable tube is inflated it takes on the desired shape. The elastic thermoplastic also provides the tube with airtight qualities such that, in a preferred embodiment of the invention, the pre-shaped inflatable tube is bladderless. The envelope 1 also has at least one second chamber 3 that is inflated to a pressure lower than the airtight shape-forming chamber 2. The shape-forming chamber 2 at least partially surrounds the second chamber 3, preferable defining a structural edge of the envelope 1. The second chamber 3 is preferably formed by fabric sheets or walls 4, 5 attached to and supported by the shape-forming chamber 2 that is providing a structural edge for the envelope 1. An upper wall 4 having an upper wall periphery is attached to the upper edge of the shape-forming chamber 2 and a lower wall 5 having a lower wall periphery is attached to the lower edge of the shape-forming chamber 2. The upper and lower walls 4, 5 are spaced apart and define between them the second chamber 3. It will be noted by a skilled person that the upper and lower walls 4, 5 no only form the walls of the second chamber 3 but also walls of the envelope 1.

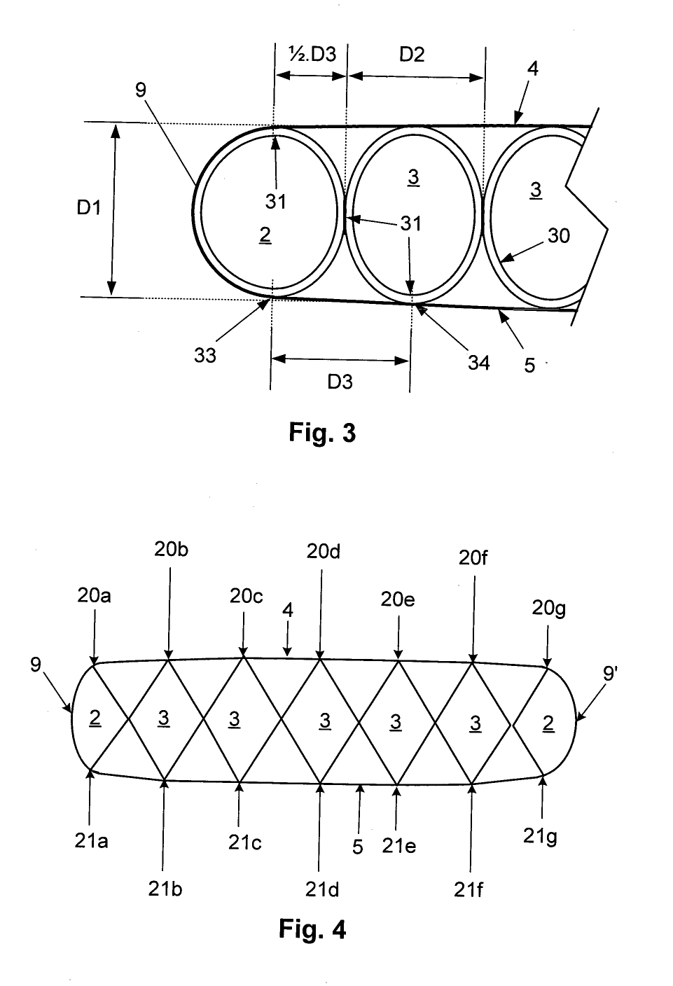

In some embodiments the upper wall 4 and/or the lower wall 5 is made from a material having an elasticity and/or a stiffness that is different from the other one of the walls 4, 5 and/or from the elasticity and stiffness of the material of the shape-forming chambers 2 (tubes 50). The difference in elasticity and stiffness affects the compression and stretch characteristics of the upper and lower walls 4, 5 which in turn affects the shape and stiffness of the envelope 1. For example, if the upper wall 4 is stiffer to resist lateral (transverse) and longitudinal compression this can help prevent an inflatable watercraft from bending under the weight of a user sitting or standing on the watercraft. The lateral, or transverse, may also be achieved via controlled attachment of the secondary shape forming ribs or tubes with respect to the upper and lower skins and distance between the skins as discussed later with respect to FIG. 3.

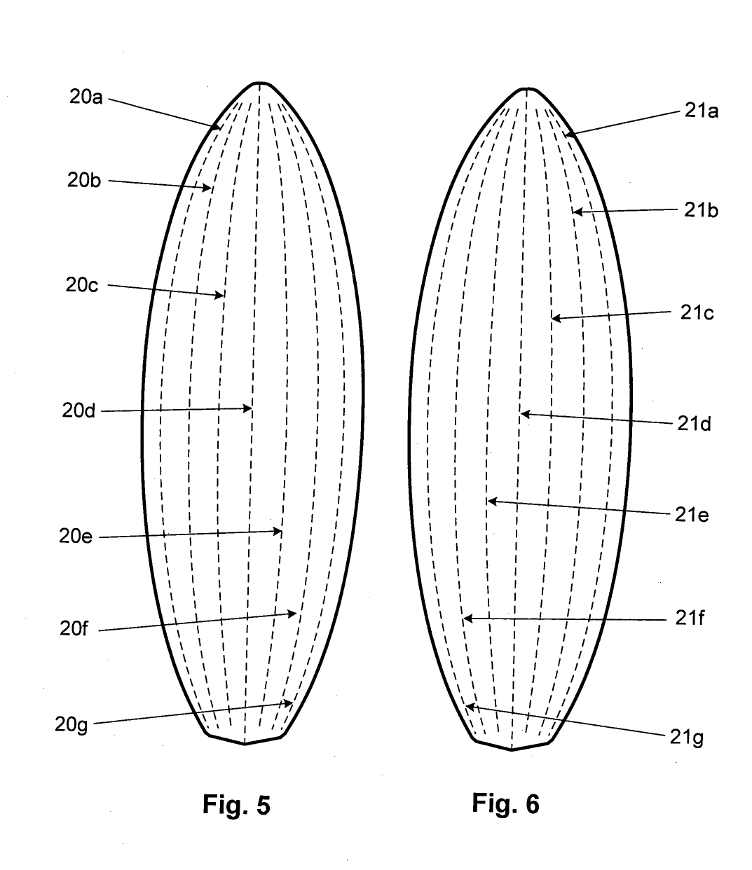

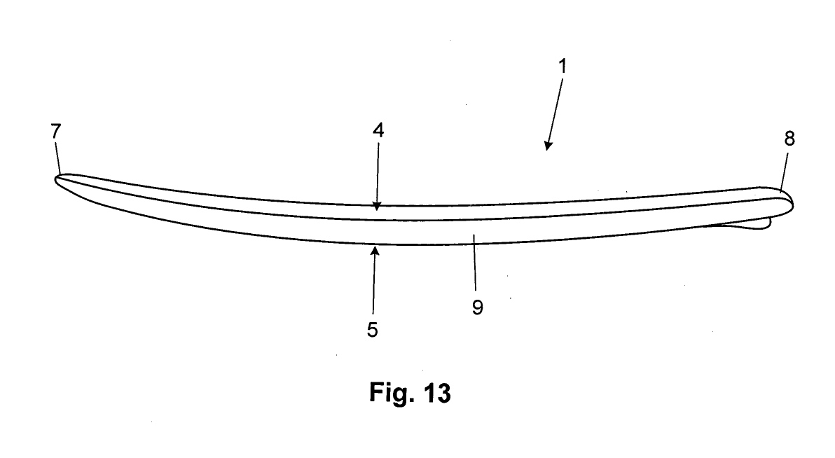

In some embodiments the second chamber 3 provides the non shape-forming or non-structural elements of the envelope 1. In such embodiments the second chamber 3 is inflated to a pressure lower than the shape-forming tubes 2, but higher than atmospheric pressure although this is not essential to the invention and the second chamber 3 may be at atmospheric pressure. In order to prevent the upper and lower walls 4, 5 from bulging and to give shape to the upper and lowers walls 4, 5 and envelope 1, the secondary chamber 3 includes one or more, preferably a plurality of, secondary shape-forming members 6 joined between the upper wall 4 and the lower wall 5. The secondary shape-forming members 6 prevent the upper and lower walls 4, 5 from bulging apart under pressure by defining a maximum distance between the upper and lower walls 4, 5. In the preferred embodiment the secondary shape-forming members 6 extending longitudinally and/or transversely within the second chamber 3 of the envelope 1 to define different maximum distances between the upper wall 4 and the lower wall 5 at two or more positions spaced apart longitudinally and/or transversely. Defining different maximum distances between the upper and lower walls 4, 5 provides shape to the envelope 1 such that the upper wall 4 and lower wall 5 are not parallel in a respective longitudinal or transverse direction. This can be used for example to provide rocker between the nose 7 and tail 8 of a paddleboard, as illustrated in FIG. 13, and also to reduce the thickness of the board laterally towards its side edges 9 and longitudinally towards its front 7. The secondary shape-forming members 6 can be one or more threads joining the upper wall 4 and the lower wall 5, or can be one or more ribs joining the upper wall 4 and the lower wall 5. In some embodiments the ribs are cross, or X-ribs and illustrates in FIGS. 3, 4, 7 and 8, or planer vertical I-ribs as illustrated in FIG. 9. In some embodiments the ribs form spaces or chambers 3 into which inflatable bladders are inserted. In other embodiments the ribs themselves are one or more second airtight shape-forming tubes 30, of the same of similar type to the pre-shaped inflatable tubes 50, attached directly to and between the upper wall 4 and lower wall 5 using suitable glue 31. The inflatable bladders inserted into spaces formed by ribs, or alternately the airtight shape-forming tubes 30, can be inflated to a third pressure higher than the second pressure and equal or lower than the first pressure. Also, in the preferred embodiment a plurality of secondary shape-forming members 6 may extend transversely through the envelope 1 to divide the second chamber 3 into two or more secondary chambers 3. In the attached drawings, FIGS. 1, 2 and 3 illustrates embodiments of a SUP in which the secondary shape forming members are airtight shape-forming tubes 30, and FIGS. 4 through 9 illustrates embodiments of a SUP in which the secondary shape forming members are ribs forming spaces 3 into which inflatable bladders are inserted. The ribs are cut and shaped to give transverse and front-back shape to the SUP, and the inflatable bladders may be made as per the description herein as pre-shaped tubular bladders to aid in shaping the SUP in the transverse and front-back directions.

Referring to FIG. 3, in order that the upper and lower walls 4, 5 are tightly stretched transversely across the envelope 1 when the airtight chambers are inflated, the secondary shape-forming members 2 can be one or more second airtight shape-forming tubes 30 which are attached at the top and bottom to the top wall 4 and bottom wall 5 respectively and at each side to an adjacent inflatable shape-forming member such that when fully inflated the tubes 30 are oval having a height D1 that is greater than a width D2. A tube or other soft-sided container will try to form a uniform circular or spherical shape when inflated. By making the distance D3 between the attachment points, say 33 and 34, of adjacent inflatable shape-forming tubes less than the normal unconstrained inflated diameter of the tubes the tubes are forced to the oval shape having a height D1 that is greater than a width D2. The inflated tubes will however try to conform to the natural circular shape. This characteristic of wanting to move from the constrained oval shape to the natural circular shape exerts a lateral tensioning force transversely through the envelope which causes the upper and lower walls 4, 5 to be pulled tight in the inflated envelope. The lateral width of the inflated tubes D2 is preferably under normal conditions the same as the distance between the attachment points, say 33 and 43, of adjacent inflatable shape-forming tubes. The distances D2 and D3 should be less than the height D1 of the inflated tubes. This principle for achieving lateral, or transverse, tension in a SUP may be equally applied to an X-rib embodiment as illustrated in FIGS. 4 through 8, or to an airtight shape-forming tube embodiment as illustrated in FIGS. 1 through 3.

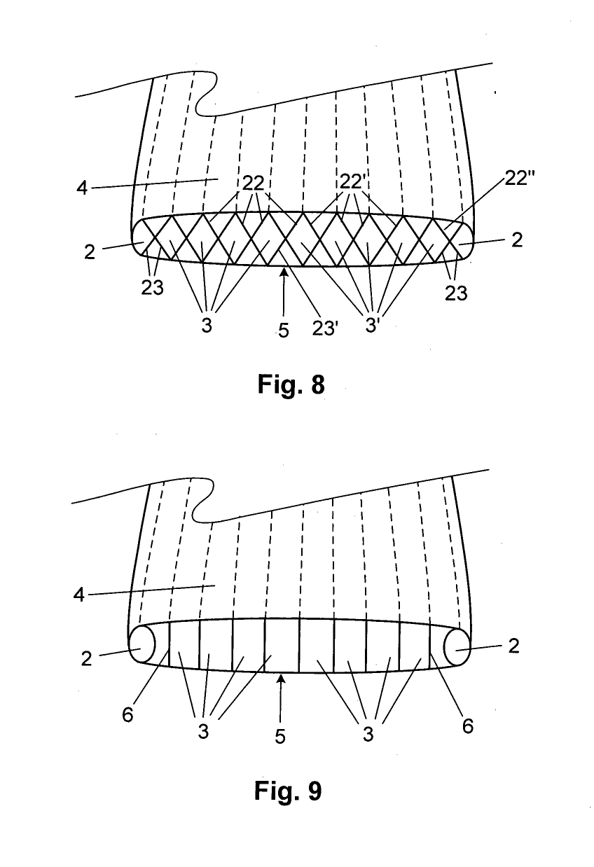

FIGS. 4 through 8 illustrate a method of forming a shaped inflatable envelope suitable for use in a SUP of other inflatable product. The container of this embodiment has a plurality of individually shaped cross or X ribs arranged laterally through the container with each rib running the full length or substantially the full length of the envelope. The envelope in the illustrated embodiment forms an SUP. FIGS. 4 and 8 illustrate a cross section through the SUP envelope. Each laterally arranged X-rib forms a space or chamber into which an inflatable bladder is inserted. The attachment points 20, 21 of the ribs to the upper and lower walls 4, 5 and crossing point between adjacent spaces 3 are arranged in the manner discussed with reference to FIG. 3 such that inflation of the bladders exerts a lateral tensioning force transversely through the envelope which causes the upper and lower walls 4, 5 to be pulled tight in the inflated envelope. The size of the x-ribs and bladders is preferably reduced towards the edges 9 of the envelope to provide transvers shape to the envelope as evident particularly from FIG. 8.

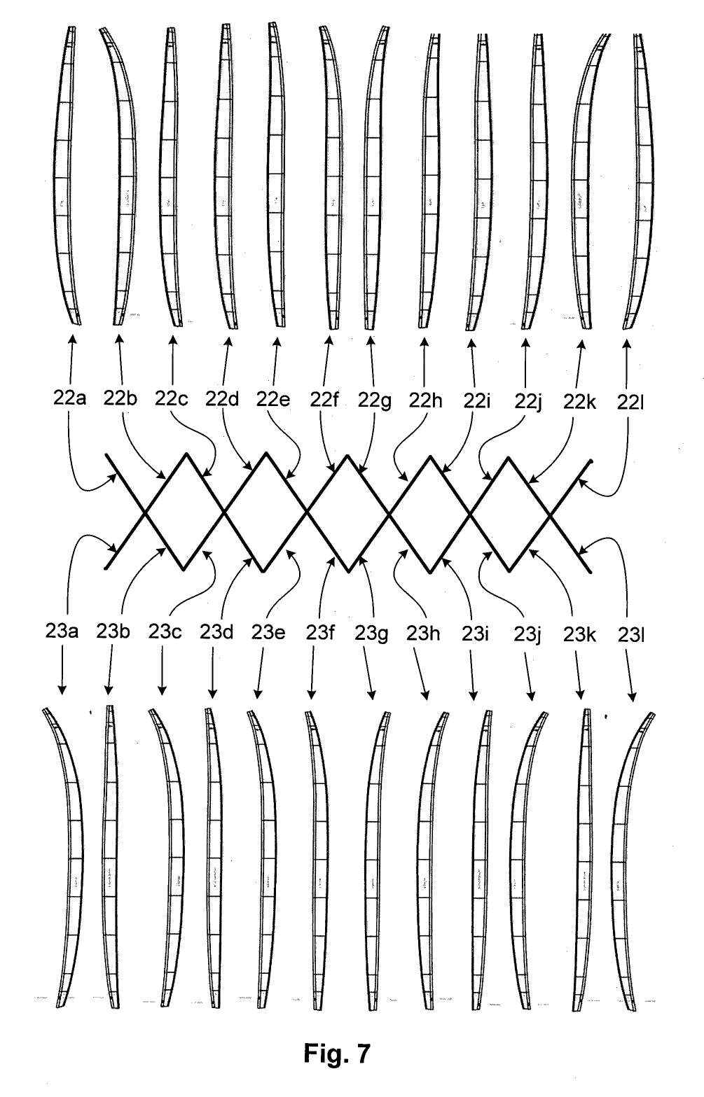

Turning particularly to FIG. 7, the transverse size of the x-ribs are lengthwise shape of the rib is controlled by separately cutting upper and lower wall panels to each rib and welding the panels together to form the x-ribs. In FIG. 7 there is shown a plurality of upper x-rib panels 22 and a plurality of lower x-rib panels 23. Pairs of adjacent upper panels 22 and pairs of adjacent lower panels 23 are joined at a respective upper and lower edge and the upper and lower adjacent pairs joined at lateral edges to define an X-rib with adjacent X-ribs defining internal space 3 between them for an inflatable bladder. For example, pair of upper panels 22a, 22b and pair lower panels 23a, 23b form a first X-rib, while pair of upper panels 22c, 22d and pair lower panels 23c, 23d define an adjacent X-rib. Utilising pairs of adjacent upper and lower shaped panels in this way provides X-ribs that give lateral and lengthwise shape to the envelope.

Referring to FIGS. 10 and 11, airtight shape-forming tubes 50 are used to provide the first shape-forming chambers 2 of the inflatable structure and also optionally the secondary shape-forming members 30 within the second chamber 3, or pre-shaped tubular bladders for inserting into space provided by ribs. Pre-shaped inflatable tubes are made from a plurality of flexible stretch resistant threads or fibres that are bonded together by an elastic plastic such as thermoplastic polyurethane (TPU). Such a pre-shaped tube can be made, for example, by firstly making an airtight tube on a forming mandril. The mandril can be tapered in one direction to make a straight tapered tube. In a second process the tube in located within a curved mould and is inflated while being reheated to form a curved tapered tube.

Referring specifically to FIG. 10, the structure of the tube is in the preferred embodiment a woven sock 53 sandwiched between two layers 51, 52 of the elastic plastic material. Preferably the woven sock comprises low stretch or stretch resistant fibres, such as high tenacity polyester fibres, arranged in a cross-ply pattern. The cross ply pattern, as shown in FIG. 12, consists of a first plurality of parallel strands arranged at an angle of preferably 45 degrees to the longitudinal axis of the sock and a second plurality of parallel strands arranged at an angle of preferably 135 degrees (or −45 degrees) to the longitudinal axis of the sock, such that the first and second plurality of strands are at an angle of 90 degrees to each other. This provides the sock with the best combination of both longitudinal and diametric (transverse) stretch resistance. A first inner layer 51 of the elastic plastics material is an inner tube having a first melting point. The inner tube is located over the mandril. The woven sock 53 is then located over the inner tube 51 of elastic plastic. A second outer tube 52 of elastic plastic is then located over the sock 53 and inner tube 51. The outer tube 52 of elastic plastic has a lower melting point than the inner tube 51. The combination is then heated to a temperature above the melting point of the outer tube 52, but just below the melting point of the inner tube 51. The temperature should be enough to soften the inner tube 51, but not melt it. The outer tube 52 melts and bonds to the sock and the inner tube 52 to set the fibres of the sock into shape. Because the inner tube 51 is softened but not melted its remains as an airtight liner bonded to both the sock 53 and outer layer 52. After forming on the mandril the straight and optionally tapered airtight tube 50 is removed from the mandril.

The airtight tube 50 is then curved in a second moulding process. Referring specifically to FIG. 11, the tube 50 has its ends sealed with resilient plugs. One end plug has a port for inflating the tube 50. The tube 50 located between mould halves 61, 62 having respective curved mould cavities 63, 64. The mould halves 61, 62 are then closed and the tube 50 is inflated to forces the tube into the mould cavity deforming the tube 50 to the shape of the mould cavities. The mould is then heated to the temperature above the melting point of the outer tube 52, but just below the melting point of the inner tube 51. The elastic plastic then resets the tube 50 to the curved shape of the mould cavities 63, 64. The elastic plastic or TPU locks the fibres or threads of the sock 53 to the shape of the mould 61, 62 such that when the inflatable tube 50 is inflated it takes on the desired shape. Ends of the pre-shaped inflatable tube 50 can be sealed either by crimping or by inserting a suitably resilient plug in the ends of the tube 50 as required by the application. The elastic thermoplastic also provides the tube with airtight qualities such that the pre-shaped inflatable tube is bladderless.

In an alternative process the pre-shaped tubes or bladders could be made by cutting pattern panels of an air impervious fabric or material and seam welding or welding and taping the seams to form pre-shaped airtight tubes.

1. An inflatable structure comprising an envelope having a first airtight shape-forming chamber and a second chamber, and wherein, in use, the first airtight shape-forming chamber is inflatable to a first pressure that is higher than a second pressure to which the second chamber is inflated.

2. The inflatable structure of claim 1 wherein the second chamber is an airtight chamber and, in use, the second chamber is inflatable to a pressure higher than atmospheric pressure but less than the first pressure.

3. The inflatable structure of claim 1 wherein the first airtight shape-forming chamber at least partially surrounds the second chamber.

4. The inflatable structure of claim 1 wherein the first airtight shape-forming chamber defines an edge of the envelope.

5. The inflatable structure of claim 1 wherein
the envelope includes an upper wall having an upper wall edge,
the upper wall is attached to the first airtight shape-forming chamber along the upper wall edge, and
the upper wall defines a wall of the second chamber.

6. The inflatable structure of claim 5 wherein
the envelope includes a lower wall having a lower wall edge,
the lower wall is attached to the first airtight shape-forming chamber along the lower wall edge, and
the lower wall defines a second wall of the second chamber.

7. The inflatable structure of claim 6 further including a secondary shape-forming member joined between the upper wall and the lower wall, wherein the secondary shape-forming member defines a maximum distance between the upper and lower walls.

8. The inflatable structure of claim 7 further comprising a plurality of the secondary shape-forming members extending longitudinally and/or transversely within the envelope.

9. The inflatable structure of claim 7 wherein the secondary shape-forming member includes a threaded joint at the upper wall and the lower wall.

10. The inflatable structure of claim 7 wherein the secondary shape-forming member includes a rib joint at the upper wall and the lower wall, extending through the envelope, and dividing the second chamber into two secondary chambers.

11. The inflatable structure of claim 7 wherein the secondary shape-forming member includes a second airtight shape-forming chamber inflatable to a third pressure that is higher than the second pressure and no higher than the first pressure.

12. The inflatable structure of claim 8 wherein the secondary shape-forming members are attached to the upper wall and the lower wall and to adjacent shape-forming members, such that, when inflated, each secondary shape-forming member has an oval shape with a height larger than width.

13. The inflatable structure of claim 8 wherein the secondary shape-forming members define a different maximum distance between the upper wall and the lower wall at at least two positions that are spaced apart longitudinally and/or transversely, such that the upper wall and lower wall are not parallel in a respective longitudinal or transverse direction.

14. The inflatable structure of claim 1 wherein
the first airtight shape-forming chamber is an inflatable tube having a pre-shaped tube wall, and
the tube wall comprises flexible stretch resistant threads or fibres bonded together by an elastic plastic.

15. The inflatable tube of claim 14 wherein the flexible stretch resistant threads or fibres comprise a woven tubular sock.

16. The inflatable structure of claim 14 wherein the elastic plastic is thermoplastic polyurethane.

17. The inflatable structure of claim 1 wherein the first airtight shape-forming chamber is tapered from a middle portion or one end towards a second end.

18. The inflatable structure of claim 1 wherein the first airtight shape-forming chamber has a curvilinear shape, when inflated.

19. The inflatable structure of claim 8 wherein the upper wall and/or the lower wall are made from a material having elasticity and/or a stiffness that is different from the elasticity and stiffness of the secondary shape-forming members.

20. The inflatable structure of claim 1 wherein the structure is a device selected from the group of devices consisting of, a water craft , a paddle board, an inflatable wing, a kite, a shelter, a non-rigid container, an aircraft rescue slide, and an inflatable advertising sign.

21. An inflatable structure comprising; an envelope having an upper wall, a lower wall and a plurality of airtight shape-forming chambers at at least two positions spaced apart transversely through the envelope, wherein the first airtight shape-forming chambers are affixed to the upper wall and the lower wall and engageable with adjacent first airtight shape-forming chambers, such that, when inflated,. each first airtight shape-forming chamber has an oval shape, wherein height between the upper and lower walls is greater than width between the upper and lower walls.

22. (canceled)

23. A pre-shaped tube having a pre-shaped tube wall, the pre-shaped tube wall comprising flexible stretch resistant threads or fibres bonded together by an elastic plastic.

24. The pre-shaped tube of claim 23 wherein the flexible stretch resistant threads or fibres comprise a woven tubular sock.

25. The pre-shaped tube of claim 23 wherein the elastic plastic is thermoplastic polyurethane.

26. The pre-shaped tube of claim 23 wherein the first airtight shape-forming chamber is tapered from a middle portion or one end towards a second end.

27. The pre-shaped tube of claim 23 wherein the first airtight shape-forming chamber has a curvilinear shaper, when inflated.

28. The pre-shaped tube of claim 23 wherein
the tube includes ends f the to c and that are sealed, and
the tube includes a re-sealable port for inflating the tube to above atmospheric pressure.

29. A method of making a pre-shaped tube comprising,
providing a forming member having a tapered and/or a curvilinear shape,
applying a woven tubular sock to the forming member,
deforming the woven sock to conform to the shape of the forming member, and
applying an elastic thermoplastic to the woven sock to bond together threads or fibres of the sock.

30. The method of claim 29 wherein the elastic thermoplastic is a tubular envelope applied to the forming member with the woven sock and is heated to bond the elastic thermoplastic tube to the sock and to bond together the threads or fibres of the sock.

31. The method of claim 29
wherein the forming member is a tubular cavity, with the thermoplastic tube located within the woven sock, and
including inflating the tube to deform the sock to conform to the cavity shape.

32. The method of claim 29 wherein
the forming member is a cylindrical former,
the woven sock is stretched over the former, and
the thermoplastic tube is located over the sock and heated to bond the elastic thermoplastic tube to the sock and bond together the threads or fibres of the sock.

33. An inflatable structure having an envelope wherein lateral and lengthwise shape of the envelope is defined by a plurality of spanning X-ribs defining chambers for inflatable bladders, each X-rib including pairs of upper and lower shaped panels.
